(19) United States
(12) Patent Application Publication
(10) Pub. No.: US 2013/0119766 A1
(43) Pub. Date: May 16, 2013

(54) METHOD FOR CONTROLLING UNINTERRUPTIBLE AND PARALLEL POWER MODULES

(71) Applicants: Hung-Ming Hsieh, Taipei (TW); Kai-Tsung Yang, Taipei (TW); Jui-Hung Chou, Taipei (TW); Shih-Chien Tang, Taipei (TW)

(72) Inventors: Hung-Ming Hsieh, Taipei (TW); Kai-Tsung Yang, Taipei (TW); Jui-Hung Chou, Taipei (TW); Shih-Chien Tang, Taipei (TW)

(21) Appl. No.: 13/296,409

(22) Filed: Nov. 15, 2011

(51) Int. Cl. H02J 9/00

(52) U.S. Cl. 307/64

(57) ABSTRACT

A method for controlling uninterruptible and parallel power modules has steps of parallelly and unloadably connecting multiple power modules to a load, acquiring a number and a load wattage of the power modules connected to the load and an instant load ratio, calculating a simulated load ratio in accordance with a simulated number of the power modules and the load wattage, if the simulated load ratio is closer to a half load and the redundancy requirement is met, unloading at least one of the power modules connected to the load so that other power modules connected to the load can share the additional load released from the unloaded power modules and the load ratio and output efficiency of each power module connected to the load can be enhanced.

### BACKGROUND OF THE INVENTION

1. Field of the Invention

The present invention relates to a method for controlling uninterruptible and parallel power modules, and more particularly to a method for dynamically adjusting a load ratio of each of uninterruptible and parallel power modules and raising overall output efficiency under the premise of meeting the redundancy requirement.

2. Description of the Related Art

Lots of modernized electronic equipment requires uninterruptible power supply (UPS) as a backup power source. Particularly, information equipment like computers has stricter requirement for UPS. To enhance reliability and usability of the UPS, parallel redundancy systems are brought into play. With reference to FIG. 3, a parallel redundancy system has multiple power modules 70 parallelly connected to a load 80 respectively through multiple switches 71. The switches 71 are controlled to be on or off by a controller 90. When the controller 90 turns on a switch 71, a corresponding power module is connected to the load 80 and supplies power thereto. Each of the parallel and operating power modules 70 has an equal role in the system to evenly share the load. When any power module 70 is faulty, the rest of power modules automatically share the additional load released by the faulty power module 70. The faulty power module 70 is unloaded as a corresponding switch 71 is turned off. The load-sharing method targets at ensuring high reliability of the system.

Despite the high reliability, unsatisfactory output efficiency of the power modules is still an issue to be improved in the parallel redundancy system. As described earlier, the existing parallel redundancy system employs an even sharing scheme. For instance, if a parallel redundancy system has four power modules and the load is 1200 W, through the even sharing scheme each power module shares a load of 300 W. Under the circumstance, all the power modules are supposed to have identical output efficiency. However, based on experimental results, the power modules of the parallel redundancy system perform differently when subjected to different loads. With reference to FIG. 4, the power modules operated in the range of half load (the load ratio 50%) have better efficiencies than those operated in the range of low load (the load ratio less than 30%) do.

The load-sharing scheme under a low load condition is rather inefficient from the energy-saving perspective. Whereas, the power modules in the parallel redundancy system parallelly connected to evenly share the load emphasize ensuring system reliability, which is as important as the output efficiency. Accordingly, how to take both the system reliability and the output efficiency of each power module into account needs to be tackled by a feasible solution.

### SUMMARY OF THE INVENTION

An objective of the present invention is to provide a method for controlling uninterruptible and parallel power modules for dynamically adjusting a load ratio of each of uninterruptible and parallel power modules and raising overall output efficiency under the premise of meeting the redundancy requirement.

To achieve the foregoing objective, the method for controlling uninterruptible and parallel power modules has steps of

parallelly and unloadably connecting multiple power modules to a load;

acquiring a number and a load wattage of the power modules connected to the load, and acquiring an instant load ratio;

selecting a simulated number of the power modules being smaller than the number of the power module;

calculating a simulated load ratio in accordance with the simulated number of the power modules and the load wattage;

determining if the simulated load ratio is closer to half load than the instant load ratio is and if a redundancy requirement is met; and

if the simulated load ratio is closer to half load and the redundancy requirement is met, unloading at least one of the power modules connected to the load to make the number of the power modules connected to the load equal to the simulated number of the power modules.

Under the premise of meeting the redundancy requirement (i.e. at least two power modules connected to the load), the method for controlling uninterruptible and parallel power modules can dynamically unload at least one power module connected to the load and allocate the load released from the unloaded power modules to the power modules connected to the load. Accordingly, besides increasing the load ratio and output efficiency of the power modules connected to the load, the energy-saving objective can also be achieved.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an uninterruptible and parallel redundancy system in accordance with the present invention;

FIG. 2 is a flow diagram of a method for controlling the uninterruptible and parallel redundancy system in FIG. 1;

FIG. 3 is a functional block diagram of a conventional uninterruptible and parallel redundancy system; and

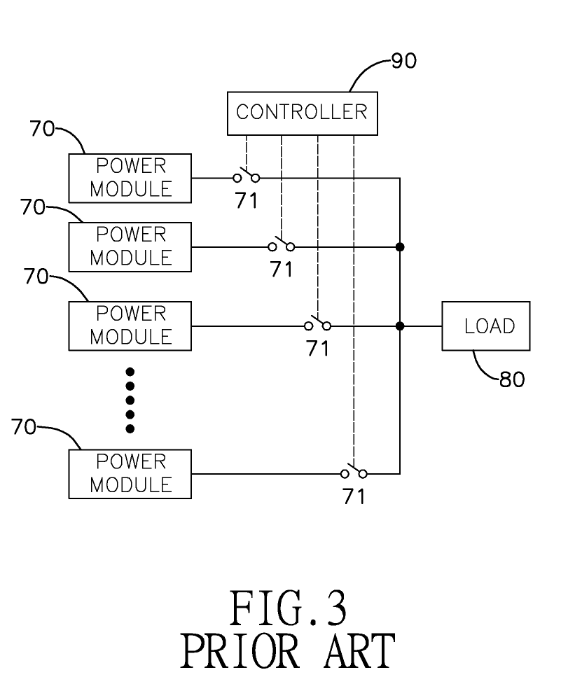

FIG. 4 is a characteristic curve plotting load ratio versus output efficiency of power modules in conventional uninterruptible and parallel redundancy systems.

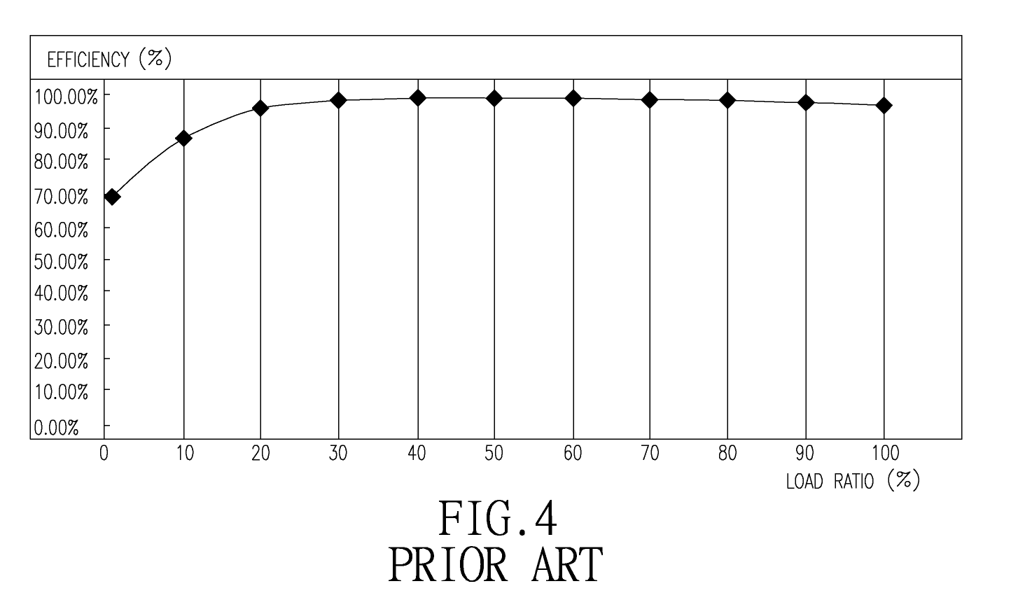

### DETAILED DESCRIPTION OF THE INVENTION

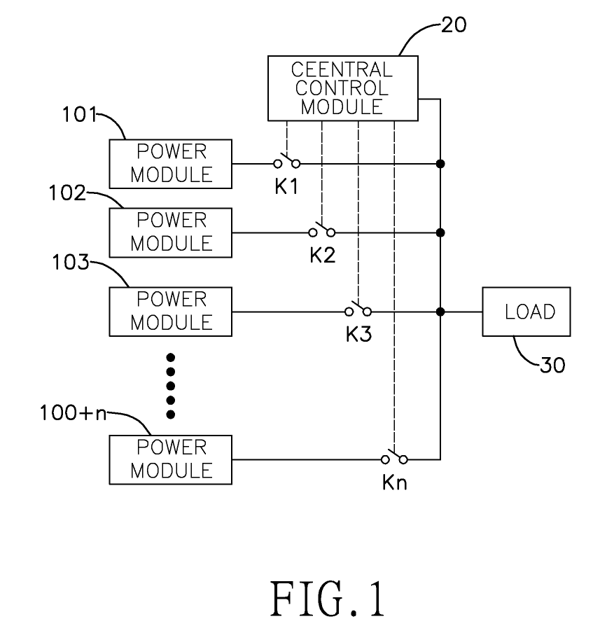

With reference to FIG. 1, an uninterruptible and parallel redundancy system in accordance with the present invention has multiple switches K1 to Kn, multiple power modules 101 to (100+n) and a central control module 20. An output terminal of each power module 101 to (100+n) is connected to a load 30 through one of the switches K1 to Kn to constitute an uninterruptible and parallel redundancy system.

Each switch K1 to Kn is controlled by the central control module to be on or off. In other words, the central control module 20 can switch each switch K1 to Kn on or off in accordance with a load condition. When any switch K1 to Kn is on, it represents that a corresponding power module 101 to (100+n) is connected to the load. On the other hand, when any switch K1 to Kn is off, it represents that a corresponding power module 101 to (100+n) is disconnected from the load 30 and is therefore unloaded.

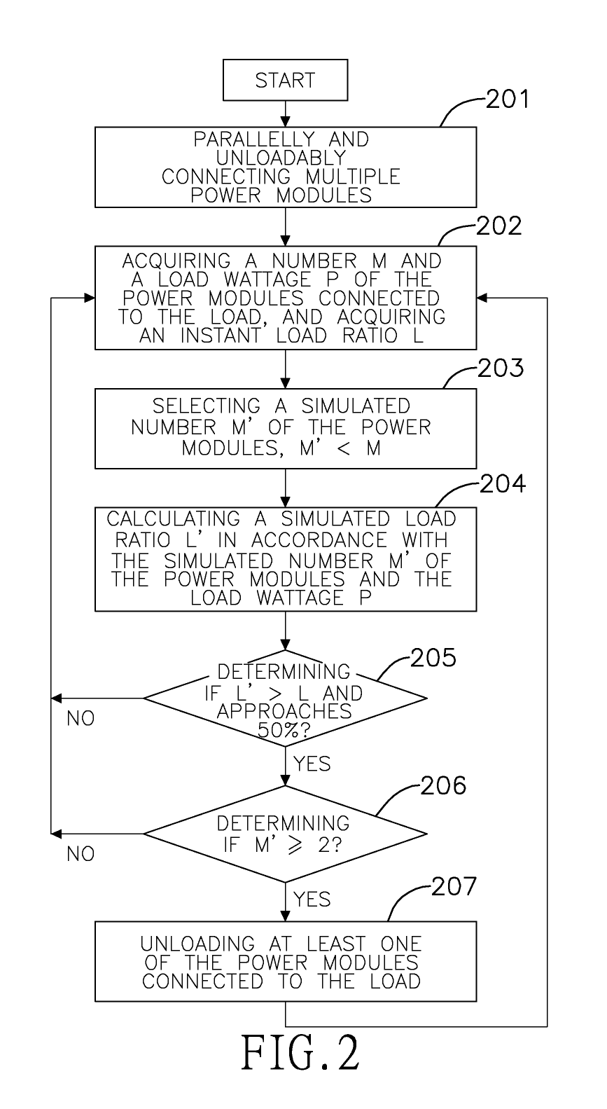

With reference to FIG. 2, a method for controlling uninterruptible and parallel power modules in accordance with the present invention is shown. The central control module 20 executes the method to determine which power module 101 to (100+n) should be connected to the load 30 so that the power modules 101 to (100+n) connected to the load 30 can have better efficiency. The method has steps of:

parallelly and unloadably connecting multiple power modules 101 to (100+n) to a load 30 (step 201);

acquiring a number M and a load wattage P of the power modules connected to the load 30, and acquiring an instant load ratio L in accordance with the following equations (step 202);

L(%)=P_{E}/P_{O}

P_{E}=P/M

where P_{E} is an average wattage; and
P_{O} is a rated wattage;

selecting a simulated number M′ of the power modules being smaller than the number M of the power module (step 203);

calculating a simulated load ratio L′ using the following equations in accordance with the simulated number M′ of the power modules and the load wattage P (step 204);

P_{E}′=P/M′

L′(%)=P_{E}′/P_{O}

M′<M

where P_{E}′ is a simulated average wattage;

determining if the simulated load ratio L′ is closer to a half load (a load ratio being 50%) than the instant load ratio L is (step 205);

when the simulated load ratio L′ is closer to the half load than the instant load ratio L is, further determining if a redundancy requirement is met (step 206); and

if the redundancy requirement is not met, maintaining the number M of the power modules connected to the load; and

if the redundancy requirement is met, unloading at least one of the power modules connected to the load 30 to make the number M of the power modules connected to the load equal to the simulated number M′ of the power modules (step 207).

The foregoing method can be exemplified as follows.

### Example 1

If the load wattage P is 1200 W, the number M of the power modules connected to the load 30 is 3, and the rated wattage P_{O} is 1800 W, then

the average wattage P_{E}=1200 W/3=400 W;

the instant load ratio L (%)=400 W/1800 W=22.2%;

assume that the central control module 20 sets the simulated number M′ of the power modules to be the number M of the power modules connected to the load 30 minus 1;

the simulated average wattage P_{E}′=1200 W/(3−1)=600 W; and

the simulated load ratio L′(%)=600 W/1800 W=33.3%.

As the simulated load ratio 33.3% is greater than the instant load ratio 22.2% and approaches the half load 50%, and the simulated number M′ of the power modules is two and thus satisfies the 1+1 redundancy requirement, the central control module 20 switches off one of the switches to disconnect a corresponding power module from the load and unload the power module. The unloaded module then stays in an idle state while the other two of the power modules connected to the load 30 need to share the additional load released from the unloaded power module. In other words, the load ratio of each of the two power modules connected to the load 30 increases from original 22.2% to 33.3%.

### Example 2

If the load wattage P is 1800 W, the number M of the power modules connected to the load 30 is 4, and the rated wattage P_{O} is 1800 W, then

the average wattage P_{E}=1800 W/4=450 W;

the instant load ratio L (%)=450 W/1800 W=22.2%;

assume that the central control module 20 sets the first simulated number M′ of the power modules to be the number M of the power modules connected to the load 30 minus 1;

the first simulated average wattage P_{E}′=1800 W/(4−1)=600 W; and

the first simulated load ratio L′(%)=600 W/1800 W=33.3%.

To verify if the simulated load ratio L′ is the optimized efficiency, the central control module 20 further sets the second simulated number M″ of the power modules to be a number deducting 2 from the number M of the power modules connected to the load 30. Under the new condition, then

the second simulated average wattage P_{E}″=1800 W/(4−2)=900 W; and

the second simulated load ratio L″ (%)=900 W/1800 W=50%.

As the second simulated load ratio 50% is greater than the first simulated load ratio 33.3% and is even closer to half load 50%, and the second simulated number M″ of the power modules is two and thus satisfies the 1+1 redundancy requirement, the central control module 20 then switches off two of the switches to disconnect two corresponding power modules from the load and unload the two power modules. The unloaded power modules then stay in an idle state while the other two of the power modules connected to the load 30 need to share the additional load released from the unloaded power modules. In other words, the load ratio of each of the two power modules connected to the load 30 increases from original 22.2% to 50%.

Consequently, when the redundancy requirement (i.e. at least two power modules connected to the load 30) is met, the method of the present invention dynamically unloads at least one power module depending upon an actual load condition and lets other power modules connected to the load share the additional load released from the unloaded power module, thereby increasing the load ratio and the output efficiency of each power module connected to the load and achieving the energy-saving objective.

Moreover, the central control module 20 can set up a duty cycle for at least one power module 101 to (100+n) connected to the load 30 to periodically get unloaded and for unloaded power module 101 to (100+n) corresponding to the at least one power module 101 to (100+n) connected to the load 30 to connect to the load 30 at the same time in accordance with the duty cycle so as to keep the number of the power modules connected to the load equal to the simulated number of the power modules. Hence, each power module connected to the load can have the chance to be idle from time to time so as to prolong its life cycle. The duty cycle can be chosen to be a few weeks or a few months to suit actual working condition.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for controlling uninterruptible and parallel power modules comprising steps of:
parallelly and unloadably connecting multiple power modules to a load;
acquiring a number and a load wattage of the power modules connected to the load and calculating an instant load ratio;
selecting a simulated number of the power modules being smaller than the number of the power modules;
calculating a simulated load ratio in accordance with the simulated number of the power modules and the load wattage;
determining if the simulated load ratio is closer to a half load than the instant load ratio is and if a redundancy requirement is met; and
if the simulated load ratio is closer to the half load and the redundancy requirement is met, unloading at least one of the power modules connected to the load to make the number of the power modules connected to the load equal to the simulated number of the power modules.

2. The method as claimed in claim 1, wherein the instant load ratio is calculated by following equations:
L(%)=P_{E}/P_{O}; and
P_{E}=P/M
where
P_{E} is an average wattage;
P_{O} is a rated wattage;
P is the load wattage; and
M is the number of the power modules connected to the load.

3. The method as claimed in claim 2, wherein the simulated load ratio is obtained by following equations:
P_{E}′=P/M′
L′(%)=P_{E}′/P_{O}
M′<M
where P_{E}′ is a simulated average wattage; and
M′ is a simulated number of the power modules.

4. The method as claimed in claim 1 further comprising steps of:
when the simulated load ratio is greater than the instant load ratio and approaches the half load, further selecting a second simulated number of the power modules to calculate a second simulated load ratio; and
when the second simulated load ratio is greater than the simulated load ratio and is closer to the half load than the simulated load ratio is and the redundancy requirement is met, unloading at least one power module connected to the load and making the number of the power modules connected to the load equal to the second simulated number of the power modules.

5. The method as claimed in claim 2 further comprising steps of:
when the simulated load ratio is greater than the instant load ratio and approaches the half load, further selecting a second simulated number of the power modules to calculate a second simulated load ratio; and
when the second simulated load ratio is greater than the simulated load ratio and is closer to the half load than the simulated load ratio is and the redundancy requirement is met, unloading at least one power module connected to the load and making the number of the power modules connected to the load equal to the second simulated number of the power modules.

6. The method as claimed in claim 3 further comprising steps of:
when the simulated load ratio is greater than the instant load ratio and approaches the half load, further selecting a second simulated number of the power modules to calculate a second simulated load ratio; and
when the second simulated load ratio is greater than the simulated load ratio and is closer to the half load than the simulated load ratio is and the redundancy requirement is met, unloading at least one power module connected to the load and making the number of the power modules connected to the load equal to the second simulated number of the power modules.

7. The method as claimed in claim 4, wherein the redundancy requirement indicates that each of the simulated number and the second simulated number of the power modules is greater than or equal to two.

8. The method as claimed in claim 5, wherein the redundancy requirement indicates that each of the simulated number and the second simulated number of the power modules is greater than or equal to two.

9. The method as claimed in claim 6, wherein the redundancy requirement indicates that each of the simulated number and the second simulated number of the power modules is greater than or equal to two.

10. The method as claimed in claim 1, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

11. The method as claimed in claim 2, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

12. The method as claimed in claim 3, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

13. The method as claimed in claim 4, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

14. The method as claimed in claim 5, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

15. The method as claimed in claim 6, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

16. The method as claimed in claim 7, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

17. The method as claimed in claim 8, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.

18. The method as claimed in claim 9, wherein after the step of unloading at least one of the power modules connected to the load, at least one of the unloaded power modules is periodically connected to the load and at least one of the power modules connected to the load is unloaded at the same time to keep the number of the power modules connected to the load equal to the simulated number of the power modules.
